(19) United States
(12) Patent Application Publication
(10) Pub. No.: US 2004/0199584 A1
(43) Pub. Date: Oct. 7, 2004

(54) Method and system for customized configuration of an appearance of a website for a user

(76) Inventors: Evan Kirshenbaum, Mountain View, CA (US); Mark L. Sabiers, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/378,814

(22) Filed: Mar. 5, 2003

(51) Int. Cl. G06F 15/16

(52) U.S. Cl. 709/205; 709/206

(57) ABSTRACT

A method is disclosed for configuring and appearance of a website to a user of the website, based on feedback from the user. The website includes different appearance options for information displayed to different users. Feedback related to the appearance of the website is received from the user during a current session of use of the website by the user. Based on the feedback, the website diagnoses a problem perceived by the user. The appearance of the website is then changed for the user, based on the diagnosed problem. In one embodiment, users are grouped with other users and associated with user models having common appearance options. In this embodiment, a user's feedback may change the appearance of the website not only for the user but also for other users within the user's group.

### CROSS-REFERENCE TO RELATED APPLICATIONS

This application is related to U.S. patent application Ser. No. 10/---,--- (Attorney Docket No. 200207986-1), entitled “METHOD AND SYSTEM FOR EVALUATING PERFORMANCE OF A WEBSITE USING A CUSTOMER SEGMENT AGENT TO INTERACT WITH THE WEBSITE ACCORDING TO A BEHAVIOR MODEL” to Cipriano SANTOS, et al.; U.S. patent application Ser. No. 10/---,--- (Attorney Docket No. 200207988-1), entitled “SYSTEM, METHOD AND APPARATUS USING BIOMETRICS TO COMMUNICATE CUSTOMER DISSATISFACTION VIA STRESS LEVEL” to Carol McKENNAN, et al.; U.S. patent application Ser. No. 10/---,--- (Attorney Docket No. 200207991-1), entitled “APPARATUS AND METHOD FOR THEOREM CERTIFICATION WITHOUT DISCLOSING DOCUMENTS THAT LEAD TO THE THEOREM” to Mathias SALLE; U.S. patent application Ser. No. 10/---,--- (Attorney Docket No. 200207993-1), entitled “METHOD AND SYSTEM FOR SELLING AN ITEM OVER A COMPUTER NETWORK” to Evan KIRSHENBAUM, et al.; U.S. patent application Ser. No. 10/---,--- (Attorney Docket No. 200207994-1), entitled “METHOD AND SYSTEM ENABLING THE TRADING OF A RIGHT TO PURCHASE GOODS OR SERVICES” to Robert C. VACANTE, et al.; U.S. patent application Ser. No. 10/---,--- (Attorney Docket No. 200207996-1), entitled “METHOD AND SYSTEM FOR PROCESSING USER FEEDBACK RECEIVED FROM A USER OF A WEBSITE” to Mathias SALLE, et al., and U.S. patent application Ser. No. 10/---,--- (Attorney Docket No. 200309361-1), entitled “A METHOD AND SYSTEM ENABLING THE TRADING OF A FUTURES CONTRACT FOR THE PURCHASE OF GOODS OR SERVICES” to Robert C. VACANTE, et al., all of which are concurrently herewith being filed under separate covers, the subject matters of which are herein incorporated by reference.

### TECHNICAL FIELD

The technical field relates generally to software for interfacing a user with a website. More particularly, the technical field relates to a software method and system for customizing the appearance of a website to a user who accesses the website.

### BACKGROUND

In the field of computer networking, it is desirable to provide users information through the use of websites that the user accesses via a network, such as the Internet. Example websites include multiple, linked web pages that provide a graphical user interface (GUI) to the user to allow the user to transact business or to retrieve information. The appearance of the GUI varies for different websites, and the GUI may also include graphics, advertisements, textual data, etc. for the web pages.

It is desirable to make the website user-friendly so that users of the website will want to access the website. Retention of existing users is particularly important for e-commerce websites that directly or indirectly earn revenue from users of the website. To ensure that users are happy with the website, it is desirable to know the users' needs. Different users may prefer different types of information displayed on the GUI. For example, younger users may prefer certain options for the website, while older users may prefer other options. Some users may prefer numerous complicated graphics for the website, while other users may prefer no graphics. Some users may prefer lots of information, for example regarding products for sale through the website, while others may prefer less information.

Some websites allow users to directly customize certain web pages, for example, by selecting a language option between English and Spanish. For many websites, however, it is not desirable to require or allow the user to directly specify changes to the website. Short of allowing users to directly configure the website, existing websites provide no way of satisfying all users' appearance preferences for the website GUI. As a result, websites that choose one GUI appearance option risk losing users who do not like that appearance. Websites that allow the user to customize the website appearance risk losing users who do not want to take the time to expressly configure the appearance options for the website. What is needed is a better means of customizing appearance preferences of websites to users.

### SUMMARY

A method is disclosed for configuring and appearance of a website to a user of the website, based on feedback from the user. The website includes different appearance options for information displayed to different users. Feedback related to the appearance of the website is received from the user during a current session of use of the website by the user. Based on the feedback, the website diagnoses a problem perceived by the user. The appearance of the website is then changed for the user, based on the diagnosed problem. In one embodiment, users are grouped with other users and associated with user models having common appearance options. In this embodiment, a user's feedback may change the appearance of the website not only for the user but also for other users within the user's group.

A tangible computer-readable medium is also disclosed having computer-executable instructions for performing a method of customizing a website for a user. The website is displayed for the user. The website includes multiple linked web pages that may be configured to different appearance options for different users. Users are associated with user models and different user models include different appearance options for display of the website. The website includes a feedback mechanism displayed on each of the web pages for selection by the user to provide feedback regarding the appearance of the website. Feedback is received from the user, and a problem with the website appearance is diagnosed based on the feedback. The appearance of the website is changed for the user based on the diagnosed problem. If the website has received a threshold number of complaints from other users regarding the problem, then the problem is recognized as a common problem for members of the user's group and the user model for the group is changed to reflect the new appearance option.

A computer-based website is also disclosed having a graphical user interface (GUI) that includes different appearance options for different users. The website groups users according to user models, and associates different GUI appearance options with different user models. The GUI is displayed for a user accessing the website during a current session of use and initially displays the appearance options specified in the user model associated with the user. A feedback mechanism is displayed on the GUI during the current session to enable the user to express satisfaction or dissatisfaction regarding the appearance of the GUI. The website receives a user selection of the feedback mechanism and diagnoses a problem with the appearance based on the feedback. Based on the diagnosed problem, the appearance of the website is changed for the user providing feedback.

### DESCRIPTION OF THE DRAWINGS

The detailed description will refer to the following drawings, wherein like numerals refer to like elements, and wherein:

FIG. 1 shows a block diagram of a computer system in which a user accesses a website via a network;

FIG. 2 is a flow chart of a method of processing feedback from a user of a website; and

FIGS. 3A-C are example screen displays illustrating feedback mechanisms.

### DETAILED DESCRIPTION

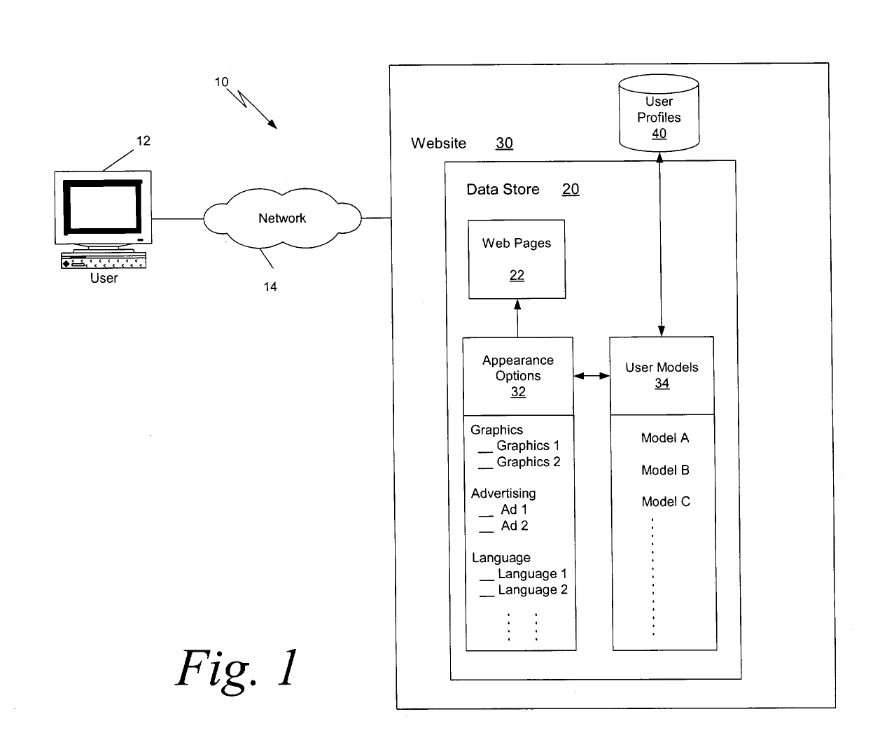

FIG. 1 is a block diagram of a computer system 10 in which a user 12 accesses a website 30 via a network 14, such as the Internet. The user 12 may connect to the network 14 using a user agent, such as a web browser running on a computer, personal data assistant (PDA), or other terminal device. The website 30 displays multiple linked web pages 22 using a graphical user interface (GUI) (not shown) with which the user 12 interacts. The website 30 includes a data store 20 that stores the web pages 22 and appearance options 32 and user models 34 that specify the appearance of the web pages 22. Although FIG. 1 shows only one user 12, in use the system 10 may include multiple users (e.g., 12) who access the website 30 through the network 14.

The website 30 also stores user data in a user profiles database 40. A user profile is created for each of the users (e.g., 12) and is stored in the database 40. The user profile includes user data specific to the user (e.g., 12). For example, the user profile includes personal information, user preferences, etc. The user profile may be created by obtaining user data both actively and passively. In one example, user data is obtained actively by specifically requesting that the user 12 provide personal information, and user data is obtained passively by tracking the user's activity with the website 30. Initially, the user profile might include information such as the time of day the user 12 accesses the website 30; the type of web browser used by the user 12; the connection speed between the website 30 and the user 12; the Internet protocol (IP) address of the user 12; whether or not the user 12 is using a proxy of the user's Internet service provider (ISP), if any; the referring web page; and any other information provided by the user's browser via the connecting protocol, e.g., hypertext transfer protocol (HTTP), when the user 12 requests web pages 22.

As the user 12 accesses the website 30, the website 30 gathers information based on the user's interaction with the website 30. This information includes, for example, information showing which portions of the website 30 were accessed by the user 12, how often the user 12 accesses the website 30, what time of day the user 12 accesses the website 30, how often the user purchases goods or services from the website 30, and how much time the user 12 typically spends on the website 30, as applicable. The user profile also includes express feedback received from the user 12, as described further herein.

The website 30 includes multiple appearance options 32 for the GUI. For example, the GUI may include multiple options for the appearance of graphics. One graphics appearance option might include a maximum number of graphics on the GUI, while another option may include only minimal graphics. In the example of FIG. 1, two graphics appearance options are shown, described as “Graphics 1” and “Graphics 2.” Other implementations may use more than two graphics appearance options. Also in the example of FIG. 1, the appearance options 32 for the website 30 include two options for advertisements and two options for language. By way of example, one advertising option might display numerous advertisements on the website 30, while another advertising option may display few or no advertisements on the website 30.

Also in the example of FIG. 1, two language options are shown. By way of example, one language option may display language in English, while another language option uses Spanish. In another example of the language option, various dialects or other forms of the same language may be used. For example, one language option might use formal English, while another option uses slang used by teenagers, while still another option explains matters in much simpler and more basic language adapted to younger users. Although the invention is described with respect to these particular options, one skilled in the art will recognize that various other categories and examples of appearance options 32 may be used.

The user profile also includes user preferences related to the appearance of the website GUI. The appearance of the website GUI varies depending upon the particular user (e.g., 12) and is determined by user data contained in the user profile. In the embodiment shown in FIG. 1, each user (e.g., 12) is associated with one of the user models 34, depending upon the user profile. For example, users who are older, have a slower connection speed, and visit the website infrequently might be associated with user Model A, while users who frequently access the website 30, often spend a lot of money on goods or services at the website 30, and have a higher connection speed might be associated with user Model B. More specifically, users who frequently provide feedback complaining that the website 30 contains too many advertisements or graphics might be associated with user models 34 that include appearance options 32 for fewer advertisements of graphics.

Users (e.g., 12) of the website 30 are grouped based on the users' similar website usage habits. Users (e.g., 12) may be grouped based on a fixed rule using demographic information in the users' profiles. Users (e.g., 12) may also be grouped based on the users' previous sessions with the website 30 or by any other perceived similarities with other users. Users within a group are associated with user models 34 that control GUI appearance options for the website 30.

User models 34 are used to group appearance options 32 available for the appearance of the GUI. In the example of FIG. 1, user models 34 include “Model A,” “Model B,” “Model C,” etc. Each of the models 34 includes a defined set of selections from the appearance options 32. For example, user model “Model A” might include the appearance options “Graphics 2,” “Ad 1,” and “Language 1.” User model “Model B” might include appearance options “Graphics 1,” “Ad 1,” and “Language 2.”

A user model is assigned to each of the users (e.g., 12) of the website 30 initially. As the user 12 accesses the website 30 and the website 30 receives feedback from the user 12, a different user model may be associated with the user 12 to more closely match the user's preferences. For example, based on initial user data, the website 30 may conclude that the user 12 is a younger individual who prefers more graphics on the website GUI. The user 12 may be associated initially with a user model on this basis. If, after the user 12 accesses the website 30 a number of times, the website 30 determines that the user 12 prefers fewer graphics, then the user 12 may be associated with a different user model that more closely matches the user's website GUI preferences. In one embodiment, a new user model may be created for the user 12 if the user 12 does not fit within one of the existing user models.

In one embodiment, all users associated with a particular user model view the same appearance preferences. For example, a user 12 associated with user Model A accesses the website GUI with the same appearance options as all users associated with user Model A (unless the user 12 is thereafter associated with a different user model, in which case the user 12 accesses the website GUI with the same appearance options as other users associated with the different user model).

In another embodiment, the set of appearance options may vary for each individual user, and even those users associated with the same user model may have different appearance options. The user profile stores each specific appearance option associated with the user 12. The user 12 is initially associated with one of the user models. Thereafter, the website 30 receives feedback from the user 12 related to the appearance of the website GUI. Feedback is provided by the user 12 via a feedback mechanism displayed on the GUI. The appearance options are changed for the user 12 in response to the feedback. In one embodiment, the user 12 remains associated with one of the user models 34, even though one or more of the appearance options 32 in the user model have changed for this particular user 12.

In one embodiment, user feedback changes the appearance options not only for the user 12 providing the feedback, but also for all other users associated with the same user model. For example, if the website 30 receives, from users who are all associated with one user model, a threshold number of complaints about a particular appearance option, then the user model will change with respect to the particular appearance option and all users associated with the user model will observe changed appearance options. For example, if user Model A is associated with the Graphics 1 graphics appearance option, and the website 30 receives numerous complaints about the graphics appearance from users associated with Model A, then the website 30 may modify Model A to include the Graphics 2 graphics appearance option instead of Graphics 1.

In one embodiment, a single complaint from a single user 12 may automatically change the user model associated with the complaining user 12. In one embodiment, users (e.g., 12) are evaluated based on the usefulness of their prior feedback. Those users (e.g., 12) who have previously provided reliable and useful feedback are given more credibility in their future feedback, and user models change more quickly in response to feedback from more credible users. Other users who provide feedback complaining frequently about problems that do not seem to affect other users are given less credibility, and accordingly less ability to modify the user model or otherwise affect appearance options for other users. In another embodiment, user models are not changed until a threshold number of complaints are received regarding the specific appearance option. For example, appearance options may not be changed in the models 34 unless 1% of the total users associated with the user model complain about the appearance and 75% of those complaining are expressing the same complaint (e.g., most of the users within the same group who provide feedback are complaining that the graphics are too busy). One skilled in the art will recognize that various threshold values may be used depending upon the needs of the website 30.

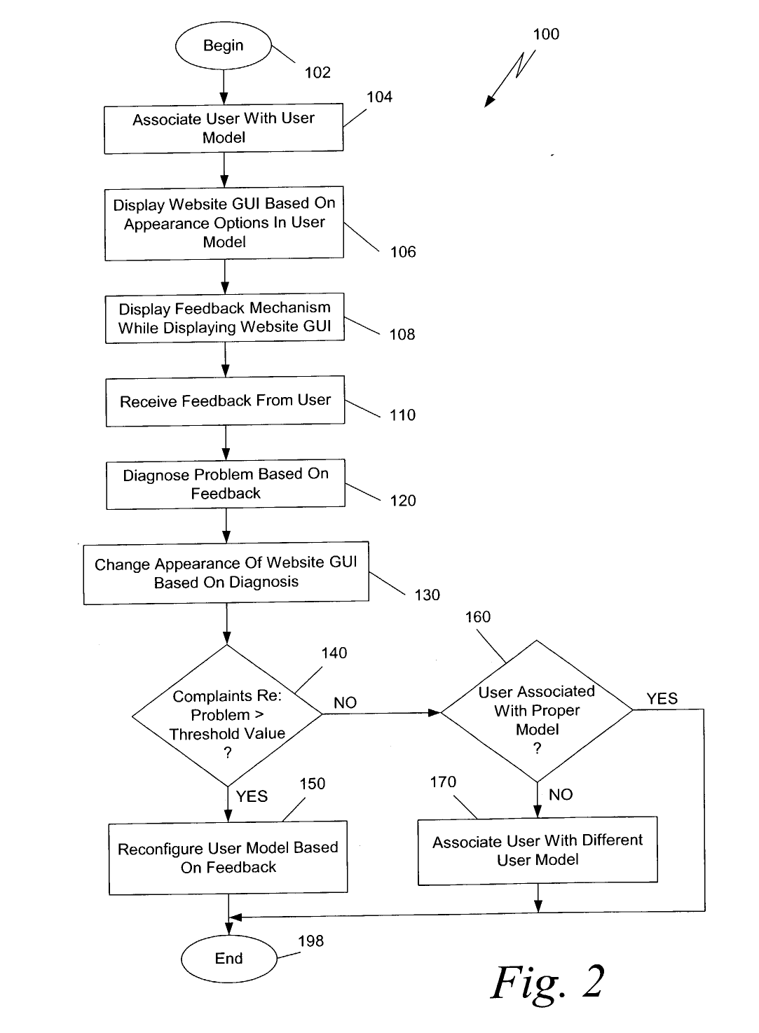

FIG. 2 shows a flow chart of a method 100 of processing feedback from a user 12 of a website 30. The method 100 begins 102 and the user 12 is associated 104 with one of the user models 34. The user 12 is identified, for example, using a “cookie” stored in the user's user agent during the user's previous session with the website 30. In one embodiment, the user 12 interfaces with a GUI of the website 30, and the user model specifies appearance options of the GUI specific to the user 12. In other embodiments, the user 12 may be identified using an explicit log-in with a password or using a credential-bearing token, such as a magnetic card or a biometric reader that reads the user's signature, retina, fingerprint, etc. As described with respect to FIG. 1, a user profile associated with the user 12 stores information related to the user 12, including GUI appearance options. When the user 12 accesses the website 30, the GUI displays 106 website information according to the appearance options specified in the user model associated with the user 12.

While displaying the website GUI, the website 30 also displays 108 a feedback mechanism. As used herein, a feedback mechanism refers to any selection feature displayed on the user's display that allows the user 12 to interact with the website to provide feedback regarding the appearance of the website GUI. The feedback mechanism allows the user 12 to indirectly change the appearance of the GUI by providing feedback regarding the user's displeasure with the appearance, and the feedback is then used by the website 30 to determine the source of the user's displeasure with the appearance and to determine whether another appearance option might be more appropriate.

In one example, the feedback mechanism is displayed on the website GUI, and in response to a selection of the feedback mechanism by the user 12, the website 30 displays a feedback menu for the user to provide feedback. The feedback menu might include one or more descriptive options for the user 12 to select, such as “too busy,” “too cluttered,” “too much advertising,” etc. In another embodiment, the feedback mechanism allows the user to select the options “happy” or “unhappy” (or similar adjectives) at any time while accessing the website 30. When the user 12 selects the “unhappy” selection, the website 30 requests additional feedback from the user 12 to more clearly explain the source of displeasure with the website appearance. In one embodiment, the feedback mechanism is incorporated into an existing menu bar as an option for selection. In another embodiment, the feedback mechanism is a slider that allows the user 12 at any time while accessing the website 30 to move the slider to express relative satisfaction with the appearance of each web page of the website 30 GUI.

The website 30 receives 110 the feedback from the user 12. Based on the feedback, the website 30 diagnoses 120 a problem associated with the feedback. The website 30 attempts to determine what appearance option caused the user to express negative feedback. Based on the problem, the system 10 reconfigures 130 the appearance of the website GUI for the user 12. For example, if the user's feedback was that the website 30 was too busy, the problem might be diagnosed 120 as having too many graphics on the website GUI. A different graphics appearance option is selected from the appearance options 32 for the website 30, and that different graphics option is associated with the user 12. In one embodiment, the user feedback is received 110, the problem is diagnosed 120, and the appearance of the website 30 is reconfigured 130 in real time. Thereafter, the modified appearance of the website GUI is used whenever the user 12 accesses the website 30. In the example above, a user 12 who complains that the website 30 was too busy would thereafter view the website 30 with fewer graphics.

In one embodiment, the change to the appearance persists for all other web pages 22 of the website 30 viewed by the user 12 during the current session of access to the website 30, and also the appearance changes are stored in the user's profile so that the appearance changes persist the next time the user 12 accesses the website 30. In one embodiment, the website GUI prompts the user 12 to specify whether the appearance changes should be temporary or permanent. Permanent changes persist for all web pages 22 requested by the user 12 during the current session of access to the website 30 and all future sessions (unless additional feedback is later provided by the user 12 changing the appearance options), while temporary changes persist only during the current session. A user 12 might want to specify that a change is temporary, for example, if the user 12 is accessing the website 30 from a terminal other than the user's regular terminal. The user's regular terminal might have a faster connection that allows enhanced graphics. When the user 12 is accessing the website 30 from a terminal with a slower connection speed, the user 12 may want to minimize the graphics. In this example, the user 12 may provide feedback that causes the website GUI to display lesser graphics while accessing from the temporary location, and the user 12 may specify that the change is merely temporary.

In another example, a change may be temporary if a user 12 allows another person to borrow the user's computer, and if the other person has different preferences. In one embodiment, the website 30 determines whether the problem is caused by a temporary situation with the website. For example, if the website 30 encountered technical problems that caused the problem for the user 12, then the problem may be a temporary problem that does not require a permanent change.

The embodiment shown in FIG. 2 allows the user feedback to also change the appearance options specified in the user model associated with the user 12. This changes the appearance of the website 30 for other users associated with the user model that is changed. In the example above, the user model might be changed such that every other user associated with the same user model views the website 30 with fewer graphics.

In the example of FIG. 2, the website 30 determines whether the user's feedback represents a problem for a significant number of other users associated with the same user model. In the specific example of FIG. 2, the website 30 determines whether the total number of complaints received by the website 30 related to the user's problem exceeds a threshold value 140. If the total number of complaints exceed the threshold value (“yes” branch at block 140), then the user model is reconfigured 150 based on the user feedback, and the method 100 ends 198. For example, if the user model was previously associated with the Graphics 1 option and the website 30 diagnoses 120 the user's problem as having too many graphics, then the user model may be reconfigured to use the Graphics 2 appearance option. If the total number of complaints do not exceed the threshold value (“no” branch at block 140), then the user model is not changed. When it is determined that a change should not be made permanent, the website 30 ensures that information relating to the problem is not used to change the user model applied to other users.

In the example of FIG. 2, if the website 30 also associates the user 12 with a different user model, if the user's feedback suggests that the user 12 more closely fits within a different model. The website 30 determines whether the user 12 is associated with the proper model 160. If the user 12 is associated with the correct model (“yes” branch at 160), then the method 100 ends 198. If the user 12 is not associated with the correct model (“no” branch at 160), then the user is associated with a different model 170, and the method 100 ends 198.

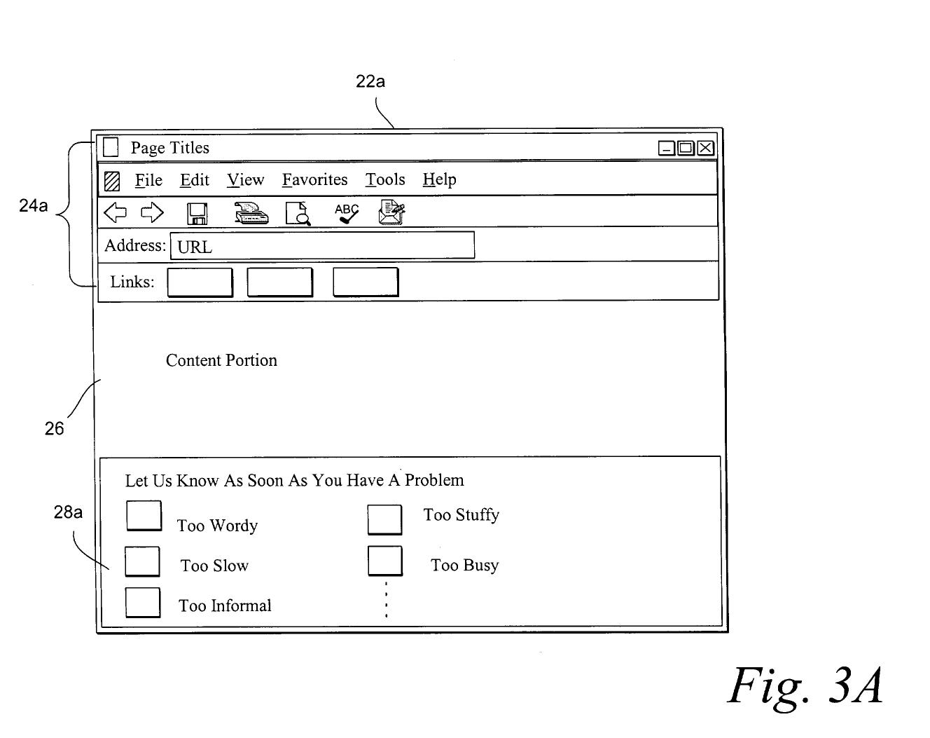

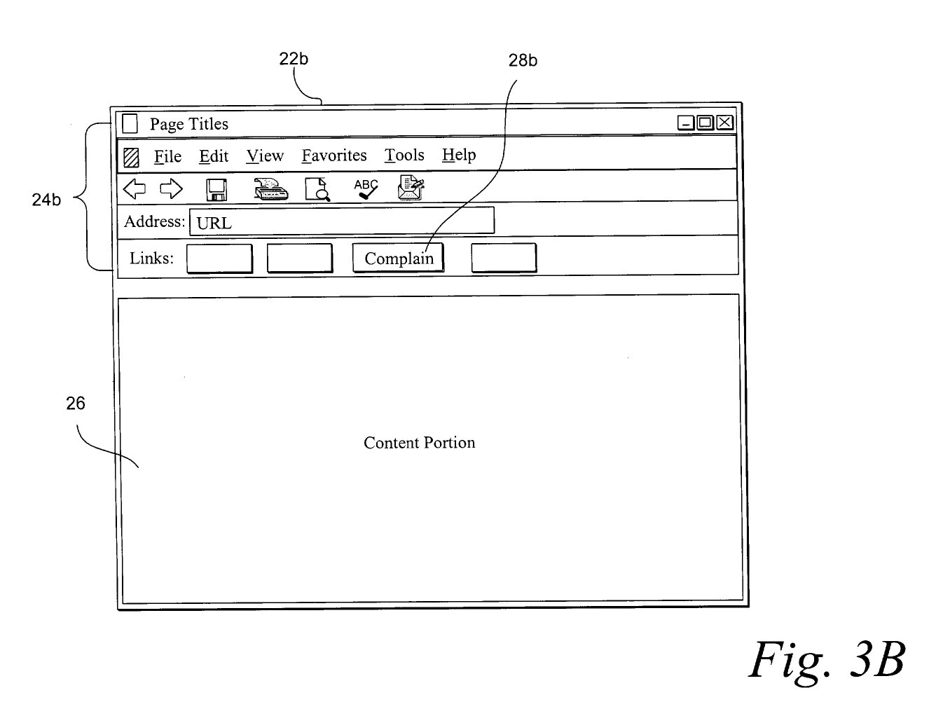

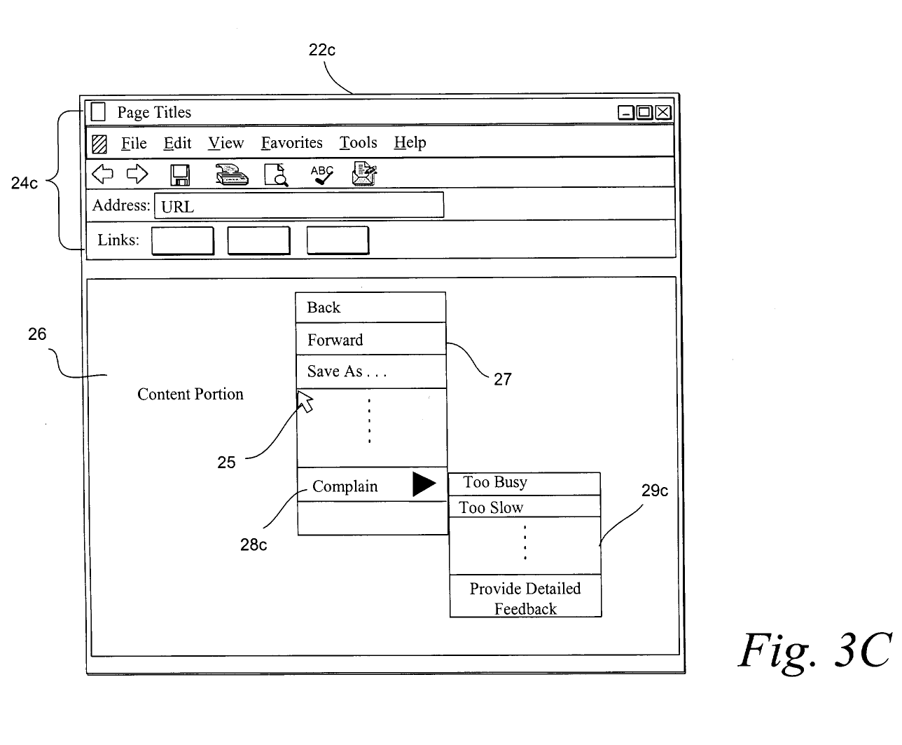

FIGS. 3A-C are example screen displays illustrating feedback mechanisms. FIG. 3A shows an example web page 22a displayed on a user's display. The displayed web page 22a is a GUI that includes tool bars 24 for traversing the website 30 and a content portion 26 that displays content of the web page 22a for the user 12. In the example of FIG. 3A, the feedback mechanism is a feedback portion 28 that displays boxes for selection by the user 12 to express dissatisfaction with the web page 22a. The feedback portion 26 appears in a frame of the web page 22a. In this example, the user 12 is allowed to select from the descriptive choices “too wordy,” “too slow,” “too informal,” “too stuffy,” and “too busy,” to describe the web page 22a. Based on the user's selection of one or more of these boxes, the website 30 diagnoses 120 a problem that gave rise to the negative feedback and reconfigures the appearance of the web page 22a based on the problem.

FIG. 3B shows an alternative embodiment of the feedback mechanism in use with another web page 22b. In the example of FIG. 3B, the feedback mechanism is a feedback button 28b positioned within the tool bars 24b. To provide feedback regarding the web page 22b, the user 12 selects the “Complain” button 28b. In response, the website 30 displays for the user 12 a list of possible complaints for the user's selection. The feedback button 28b may be installed on the user's user agent as a “plug-in” device that incorporates into the user's web browser. In one embodiment, the feedback button 28b is provided by a third party and may be installed and used by the user 12 in connection with various websites (e.g., 30).

FIG. 3C shows an alternative embodiment of the feedback mechanism in use with another web page 22c. In the example of FIG. 3C, the feedback mechanism is a feedback menu option 28c displayed on a right-click menu 27. The right-click menu 27 is used in connection with a mouse (not shown) or similar user selection device that controls a pointer 25. By right-clicking the mouse, the menu 27 is displayed and shows the feedback menu option 28c for the user 12 to complain about the appearance of the web page 22c. In the example of FIG. 3C, selection of the feedback menu option 28c causes a submenu 29c of feedback options to be displayed for the user's selection. As with the feedback button 28b shown in FIG. 3B, the feedback menu option 28c may be installed on the user's web browser as a plug-in software tool. One skilled in the art will recognize that the feedback mechanism may be implemented in various forms other than those described with respect to FIGS. 3A-C. For example, the feedback mechanism may use web page separate from, but displayed concurrently with, the web page that displays content information; a dialog box; a slider displayed on a web page; a recognized pen gesture (for a pen-based GUI); a recognized word (for a voice-activated input); a control element incorporated into the user's operating system; or a program residing on the user's computer.

Although the present invention has been described with respect to particular embodiments thereof, variations are possible. The present invention may be embodied in specific forms without departing from the essential spirit or attributes thereof. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). It is desired that the embodiments described herein be considered in all respects illustrative and not restrictive and that reference be made to the appended claims and their equivalents for determining the scope of the invention.

In the claims:

1. A method of configuring an appearance of a website to a user of the website, the method comprising:
receiving feedback from the user during a current session of use of the website by the user, wherein the website includes different options for appearance of information displayed to different users, and wherein the feedback relates to the appearance of the website to the user;
diagnosing a problem based on the feedback; and
changing the appearance of the website to the user, based on the problem.

2. The method of claim 1, further comprising associating the user with a user model based on a user profile for the user, wherein the user profile includes information based on website usage habits of the user, wherein the user model specifies appearance options for the website, and wherein the user model is associated with a plurality of other users with similar user profiles.

3. The method of claim 2,
further comprising:
prompting the other users associated with the user model with a proposed website appearance option change based on the feedback from the user;
receiving responses from the other users, wherein the responses indicate whether the other users accept or reject the proposed change; and
changing the appearance options for the other users who accept the proposed change.

4. The method of claim 2, further comprising:
determining whether a threshold number of users associated with the user model have also complained regarding the problem, and
if the threshold number of users have complained, changing the appearance options of the user model.

5. The method of claim 2,
wherein the user profile includes information based on the feedback; and
further comprising associating the user with a different user model that more closely fits the user.

6. The method of claim 2,
further comprising:
grouping users based on perceived similarities between the users, and
creating a user model for each group of users, and
wherein the step of associating comprises:
associating the user with one of the groups; and
associating the user with the user model associated with the group with which the user is associated.

7. The method of claim 2,
further comprising determining whether the problem is temporary or permanent; and
wherein the step of changing comprises changing only during the current session if the problem is temporary.

8. The method of claim 2, wherein the user profile comprises information provided by a user agent of the user when the user requests a web page from the website via a protocol, a connection speed used by the user, a referring page accessed by the user, and a time of day that the user accessed the website.

9. The method of claim 8, further comprising receiving information from the user in response to a questionnaire, and wherein the user profile comprises information related to the information received in response to the user's questionnaire.

10. The method of claim 1, wherein the step of receiving feedback comprises receiving a selection by the user of a feedback mechanism, wherein the feedback mechanism is provided to the user while the user accesses linked web pages of the website.

11. The method of claim 10, wherein the feedback mechanism allows the user to select one or more descriptions of the user's opinion of the website, and wherein the step of diagnosing comprises diagnosing based on a selection by the user among the descriptions.

12. The method of claim 10, wherein the feedback mechanism is adapted to provide feedback from the user to a plurality of websites.

13. The method of claim 1, wherein the step of diagnosing comprises:
identifying actions taken by the user while accessing the website during the current session;
determining, based on the actions, what information was displayed to the user; and
identifying the problem with the website, based on the displayed information.

14. The method of claim 13, wherein the steps of receiving feedback, identifying the actions taken by the user, determining what information was displayed, identifying the problem, and changing the appearance of the website occur automatically in real time, such that the appearance is reconfigured during the current session.

15. The method of claim 1, further comprising prompting the user to indicate whether the changing helped solve the problem.

16. A computer-readable medium having computer-executable instructions for performing a method for customizing a website to a user, the method comprising:
displaying a website for a user, wherein the website comprises a plurality of linked web pages, and wherein the website may be configured to display a plurality of appearance options associated with user models;
providing a feedback mechanism to the user, while the user accesses the web pages, wherein the feedback mechanism allows selection by the user of one or more of a plurality of descriptions of the appearance of the website;
receiving feedback from the user using the feedback mechanism, wherein the user has a user profile that includes user data for the user, and wherein the user profile associates the user with one of the user models that determines the appearance of the website for the user;
diagnosing a problem with the appearance of the website based on the feedback;
changing the appearance of the website for the user to resolve the problem; and
changing the model associated with the user, if the website has received a threshold number of complaints from other users regarding the problem.

17. The medium of claim 16, wherein the step of providing comprises providing the feedback mechanism using a software tool incorporated into a browser associated with the user.

18. A computer-based website accessible by users via a network, wherein the website executes instructions for performing a method of processing feedback from the users and changing display of a website graphical user interface (GUI) based on the feedback, the method comprising:
associating one of the users with a user model, wherein the user model includes a plurality of appearance options for the GUI;
displaying the GUI for the one of the users during a current session of access to the website, based on the user model;
displaying a feedback mechanism while displaying the GUI;
receiving feedback from the user via the feedback mechanism, wherein the feedback relates to an appearance of the GUI;
diagnosing a problem with the appearance of the website based on the feedback; and
changing the appearance of the GUI for the one of the users based on the diagnosing.

19. The website of claim 18, wherein the step of displaying the feedback mechanism comprises displaying one or more textual descriptions of the appearance of the GUI for selection by the user, and wherein the step of receiving comprises receiving a selection of one or more of the descriptions.

20. The website of claim 18, wherein the step of diagnosing comprises:
identifying actions taken by the one of the users while accessing the website during the current session of access;
determining, based on the actions, what information was displayed to the user; and
identifying the problem with the website, based on the displayed information.
